(19) United States
(12) Patent Application Publication
(10) Pub. No.: US 2002/0141501 A1
(43) Pub. Date: Oct. 3, 2002

(54) SYSTEM FOR PERFORMING RESOLUTION UPSCALING ON FRAMES OF DIGITAL VIDEO

(75) Inventor: SANTHANA KRISHNAMACHARI, OSSINING, NY (US)

Correspondence Address: CORPORATE PATENT COUNSEL, US PHILIPS CORPORATION, INTELLECTUAL PROPERTY DEPARTMENT, 580 WHITE PLAINS ROAD, TARRYTOWN, NY, 10591, US

(73) Assignee: Philips Electronics North America Corporation

(21) Appl. No.: 09/197,314

(22) Filed: Nov. 20, 1998

(51) Int. Cl. H04N 7/12

(52) U.S. Cl. 375/240.18; 375/240.16

(57) ABSTRACT

The system increases a resolution of at least a portion of a reference frame of video based on pixels in the reference frame and pixels in one or more succeeding target frames of the video. Specifically, the system selects a first block of pixels in the reference frame, and then locates, in N (N≧1) target frames, one or more blocks of pixels that substantially correspond to the first block of pixels, where the N target frames are separate from the reference frame. In the particular case of MPEG-coded video, blocks in the N target frames are located using motion vector information present in the MPEG bitstream. Values of additional pixels are determined based on values of pixels in the first block and on values of pixels in the one or more blocks, whereafter the additional pixels are added among the pixels in the first block in order to increase the block's resolution.

### BACKGROUND OF THE INVENTION

1. Field of the Invention

The present invention is directed to a system for increasing the resolution of “reference” frames of video based on pixels in the reference frames and pixels in one or more “target” frames. The invention has particular utility in connection with apparatuses, such as digital televisions and personal computers, that form images from frames of video that are coded according to an MPEG (“Motion Picture Experts Group”) standard.

2. Description of the Related Art

Conventional techniques for increasing the resolution of a frame of digital video rely solely on information in the frame itself. One such technique that has often been used is known as bilinear interpolation. Bilinear interpolation is a process which determines values of pixels based on one or more adjacent pixels in a frame, and which then assigns those values intermittently among the pixels in order to increase the frame's resolution.

More specifically, as shown in FIG. 1, bilinear interpolation involves determining an intermittent “pixel” value at a point z₅ based, e.g., on pixel values at points z₁, z₂, z₃ and z₄. Thus, given a value of a function ƒ at z₁, z₂, z₃ and z₄, using bilinear interpolation it is possible to obtain the value of ƒ at point z₅ as follows

ƒ(z₅)=ƒ(z₁)xy+ƒ(z₂)(1−x)y+ƒ(z₃)(1−y)x+ƒ(z₄)(1−x)(1−y). (1)

The value ƒ(z₅) is then assigned as the pixel value at point z₅. This is done throughout the reference frame in order to increase its resolution.

While bilinear interpolation and related techniques (e.g., replication and cubic interpolation) increase frame resolution, they have at least one significant drawback. That is, because these techniques rely only on information in the current frame, the accuracy of the interpolated pixel value, namely ƒ(z₅), is limited. As a result, while the resolution of the current frame may be increased overall, its accuracy may diminish. This decrease in accuracy is particularly noticeable following frame scaling (or “zooming”) in which the size of the current frame is increased, thereby magnifying any pixel inconsistencies or discontinuities resulting from bilinear interpolation.

Accordingly, there exists a need for a system which increases the resolution of both scaled and unscaled frames of video, and which is more accurate than the currently-available systems such as bilinear interpolation.

### SUMMARY OF THE INVENTION

The present invention addresses the foregoing needs by determining values of additional pixels for a reference frame of video based on pixels already in the reference frame and on pixels in one or more target frames of the video. By taking into account pixels from other frames (i.e., the target frames) when determining the values of the additional pixels, the invention provides a more accurate determination of the additional pixel values than its conventional counterparts described above. As a result, when the additional pixels are added among the pixels already in the reference frame, the resulting high-resolution reference frame also appears to be more accurate, even when it is scaled.

Thus, according to one aspect, the present invention is a system (e.g., a method, an apparatus, and computer-executable process steps) which increases a resolution of at least a portion of a reference frame of video based on pixels in the reference frame and pixels in one or more target frames of the video. Specifically, the system selects a first block of pixels in the reference frame, and then locates, in N (N≧1) target frames, one or more blocks of pixels that substantially correspond to the first block of pixels, where the N target frames are separate from the reference frame. In the particular case of MPEG-coded video, blocks in the N target frames are located using motion vector information present in the MPEG bitstream. Values of additional pixels are then determined based on values of pixels in the first block and on values of pixels in the one or more blocks, whereafter the additional pixels are added among the pixels in the first block so as to increase the block's resolution.

In a preferred embodiment of the invention, the N target frames were predicted, at least in part, based on pixels in the reference frame. By using predicted frames as the target frames, the invention is able to account for relative pixel motion when determining the values of the additional pixels.

In cases where there are no blocks of pixels in the target frames that substantially correspond to the first block of pixels, the invention determines the values of the additional pixels based on values of pixels in the first block without regard to values of pixels in the N target frames. One way in which this may be done is by performing standard bilinear interpolation using at least some of the pixels in the first block. By virtue of this feature of the invention, it is possible to increase the resolution of blocks that do not have counterparts in the target frames, albeit without the same degree of accuracy as those blocks that have such counterparts.

In another preferred embodiment, the system changes distances between pixels in the first block. This feature of the invention provides for size scaling of the first block and, more generally, the reference frame. In a case that the block's size is increased through scaling, the invention will make the resulting scaled block appear more accurate, meaning there will be fewer pixel inconsistencies or discontinuities than would be the case using conventional techniques.

According to another aspect, the present invention is a television system which receives coded video data, and which forms images based on this coded video data. The television system includes a decoder which decodes the video data to produce frames of video, and a processor which increases a resolution of a reference frame of the video based on pixels in the reference frame and based on pixels in at least one other target frame of the video. The television system also includes a display which displays an image based on the reference frame.

In preferred embodiments of the invention, the processor increases the resolution of the reference frame by selecting blocks of pixels in the reference frame and, for each selected block, (i) locating, in N (N≧1) target frames, one or more blocks of pixels that substantially correspond to the first block of pixels, where the N target frames are separate from the reference frame, (ii) determining values of additional pixels based on values of pixels in the selected block and on values of pixels in the one or more blocks, and (iii) adding the additional pixels among the pixels in the selected block. In the particular case of MPEG-coded video, blocks in the N target frames are located using motion vector information present in the MPEG bitstream. By virtue of these features of the invention, it is possible to convert standard-resolution video into high-resolution video for display, e.g., on a high-resolution display on the television system.

This brief summary has been provided so that the nature of the invention may be understood quickly. A more complete understanding of the invention can be obtained by reference to the following detailed description of the preferred embodiment thereof in connection with the attached drawings.

### BRIEF DESCRIPTION OF THE DRAWINGS

FIG. 1 shows a pixel block in which an additional pixel value is determined using standard bilinear interpolation.

FIG. 2 shows an overview of a television system, which includes a digital television in which the present invention is implemented.

FIG. 3 shows the architecture of the digital television.

FIG. 4 shows a video decoding process performed by a video decoder in the digital television.

FIG. 5 shows process steps for determining which type of processing is to be performed on a frame of video.

FIG. 6 shows process steps for implementing the resolution upscaling process of the present invention on blocks in a frame of video.

FIG. 7 shows a 2×2 pixel block.

FIG. 8 shows a 4×4 pixel block determined from the 2×2 pixel block of FIG. 7 using standard bilinear interpolation.

FIG. 9 shows back projecting data from a target P frame to determine additional pixel values in a reference I frame.

FIG. 10 shows a process for determining a reference macroblock in a B frame, namely frame B₁.

FIG. 11 shows back projecting data both from a target P frame and from a target B frame to determine additional pixel values in a reference I frame.

FIG. 12 shows a process for determining a reference macroblock in a B frame, namely frame B₂ using a target P frame (P₂) and a reference B frame (B₁).

FIG. 13 shows upscaling a reference block using a target block without half-pel motion vectors.

FIG. 14 shows upscaling a reference block using a target block which has half-pel motion vectors in both the horizontal and vertical directions.

FIG. 15 shows upscaling a reference block using a target block which has half-pel motion vectors in the horizontal direction and integer motion vector values in the vertical direction.

FIG. 16 shows upscaling a reference block using a target block which has half-pel motion vectors in the vertical direction and integer motion vector values in the horizontal direction.

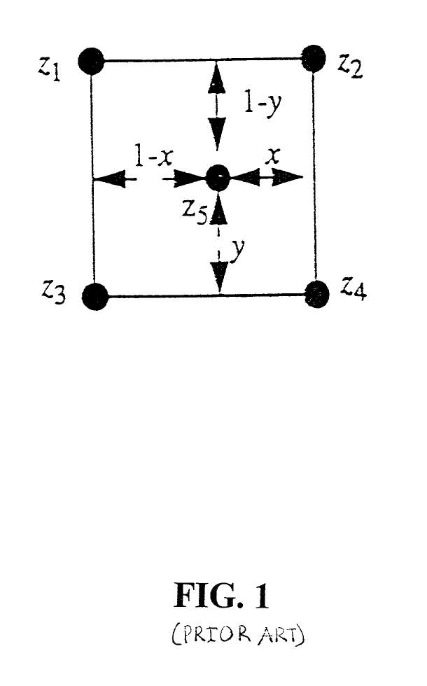

### DETAILED DESCRIPTION OF THE PREFERRED EMBODIMENT

Initially, it is noted that the present invention can be implemented by processors in many different types of video equipment including, but not limited to, video conferencing equipment, video post-processing equipment, a networked personal or laptop computer, and a settop box for an analog or digital television system. For the sake of brevity, however, the invention will be described in the context of a stand-alone digital television, such as a high-definition (“HDTV”) television.

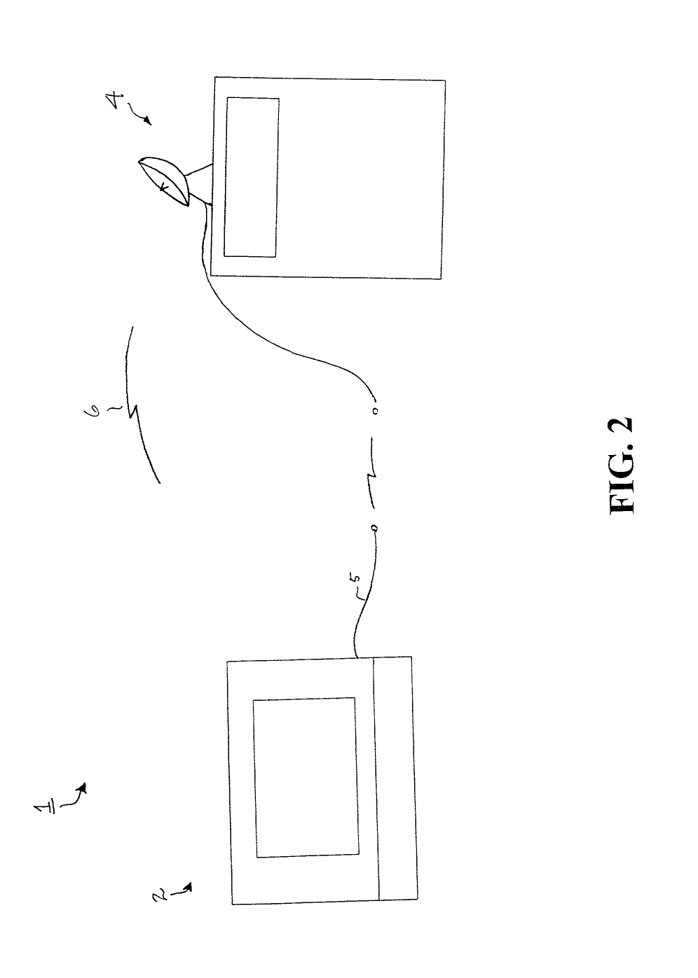

FIG. 2 shows an example of a television transmission system in which the present invention may be implemented. As shown in FIG. 2, television system 1 includes digital television 2, transmitter 4, and transmission medium 5. Transmission medium 5 may be a coaxial cable, fiber-optic cable, or the like, over which television signals comprised of video data, audio data, and control data may be transmitted between transmitter 4 and digital television 2. As shown in FIG. 2, transmission medium 5 may include a radio frequency (hereinafter “RF”) link, or the like, between portions thereof. In addition, television signals may be transmitted between transmitter 4 and digital television 2 solely via an RF link, such as RF link 6.

Transmitter 4 is located at a centralized facility, such as a television station or studio, from which the television signals may be transmitted to users' digital televisions. These television signals comprise data for a plurality of frames video, together with corresponding audio data. This video and audio data is coded prior to transmission. A preferred coding method for the audio data is AC3 coding. A preferred coding method for the video data is MPEG (e.g., MPEG-1, MPEG-2, MPEG-4, etc.); however, other digital video coding techniques can be used as well.

Although MPEG is well-know to those of ordinary skill in the art, a brief description thereof is nevertheless provided herein for the sake of completeness. In this regard, MPEG codes video in order to reduce the amount of data that must be transmitted per frame. MPEG does this, in part, by taking advantage of commonalities between different frames in the video. To this end, MPEG codes frames of video as either intramode (I) frames, predictive (P) frames, or bi-directional (B) frames. Descriptions of these frame types are set forth below.

More specifically, I frames comprise “anchor frames”, meaning that they contain all data necessary for decoding, and that the data contained therein affects coding and decoding of the P and B frames. The P frames, on the other hand, contain only data that differs from data in the I frames. That is, macroblocks (i.e., 16×16 pixel blocks) of P frames that substantially correspond to macroblocks in a preceding I frame (or, alternatively, a preceding P frame) are not coded—only the difference between frames, called the residual, is coded. Instead, motion vectors are generated which define relative differences in locations of similar macroblocks between the frames. These motion vectors are then transmitted with each P frame, instead of the identical macroblocks. During decoding of the P frames, missing macroblocks can be obtained from a preceding (e.g., I) frame, and their locations in the P frames determined using the motion vectors. The B frames are interpolated using data in preceding and succeeding frames. To do this, two motion vectors are transmitted with each B frame, which are used to define locations of macroblocks therein.

MPEG coding is thus performed on frames of video data by dividing the frames into macroblocks, each having a separate quantizer scale value associated therewith. Motion estimation, as described above, is then performed on the macroblocks so as to generate motion vectors for the P and B frames and thereby reduce the number of macroblocks that must be transmitted in these frames. Thereafter, remaining macroblocks in each frame (i.e., the residual) are divided into individual blocks of 8×8 pixels. These 8×8 pixel blocks are subjected to a discrete cosine transform (hereinafter “DCT”) which generates DCT coefficients for each of the 64 pixels therein. DCT coefficients in an 8×8 pixel block are then divided by a corresponding coding parameter, namely a quantization weight. Additional calculations are then performed on the DCT coefficients in order to take into account the quantizer scale value, among other things. Following this, variable-length coding is performed on the DCT coefficients, and the coefficients are transmitted to an MPEG receiver according to a pre-specified scanning order, such as zig-zag scanning.

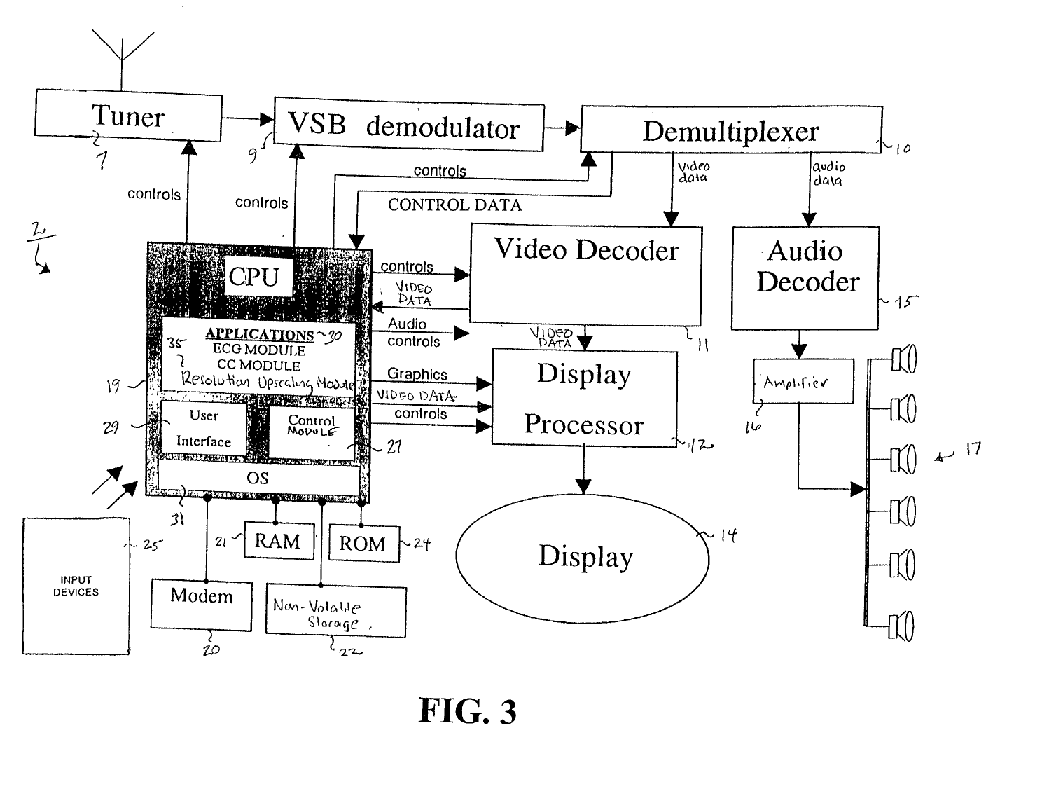

In this embodiment of the invention, the MPEG receiver is the digital television shown in FIG. 3. As shown in the figure, digital television 2 includes tuner 7, VSB demodulator 9, demultiplexer 10, video decoder 11, display processor 12, video display screen 14, audio decoder 15, amplifier 16, speakers 17, central processing unit (hereinafter “CPU”) 19, modem 20, random access memory (hereinafter “RAM”) 21, non-volatile storage 22, read only memory (hereinafter “ROM”) 24, and input devices 25. Many of these features of digital television 2 are well-known to those of ordinary skill in the art; however, descriptions thereof are nevertheless provided herein for the sake of completeness.

In this regard, tuner 7 comprises a standard analog RF receiving device which is capable of receiving television signals from either transmission medium 5 or via RF link 6 over a over a plurality of different frequency channels, and of transmitting these received signals. Which channel tuner 7 receives a television signal from is dependent upon control signals received from CPU 19. These control signals may correspond to control data received along with the television signals, (see, e.g., U.S. patent application Ser. No. 09/062,940, entitled “Digital Television System which Switches Channels In Response To Control Data In a Television Signal”, the contents of which are hereby incorporated by reference into the subject application as if set forth herein in full). Alternatively, the control signals received from CPU 19 may correspond to signals input via one or more of input devices 25.

In this regard, input devices 25 can comprise any type of well-known device, such as a remote control, keyboard, knob, joystick, etc. for inputting signals to digital television 2 (specifically, to CPU 19). As noted, these signals may comprise control signals for “changing channels”. However, other signals may be input as well. These may include signals to select a particular area of video and to “zoom-in” on that area, and signals to increase the resolution of displayed video, among others.

Demodulator 9 receives a television signal from tuner 7 and, based on control signals received from CPU 19, converts the television signal into MPEG digital data packets. These data packets are then output from demodulator 9 to demultiplexer 10, preferably at a high speed, such as 20 megabits per second. Demultiplexer 10 receives the data packets output from demodulator 9 and “desamples” the data packets, meaning that the packets are output either to video decoder 11, audio decoder 15, or CPU 19 depending upon an identified type of the packet. Specifically, CPU 19 identifies whether packets from the demultiplexer include video data, audio data, or control data based on identification information stored in those packets, and causes the data packets to be output accordingly. That is, video data packets are output to video decoder 11, audio data packets are output to audio decoder 15, and control data packets are output to CPU 19.

In an alternative embodiment of the invention, the data packets are output from demodulator 9 directly to CPU 19. In this embodiment, CPU 19 performs the tasks of demultiplexer 10, thereby eliminating the need for demultiplexer 10. Specifically, in this embodiment, CPU 19 receives the data packets, desamples the data packets, and then outputs the data packets based on the type of data stored therein. That is, as was the case above, video data packets are output to video decoder 11 and audio data packets are output to audio decoder 15. CPU 19 retains the control data packets in this case.

Video decoder 11 decodes video data packets received from demultiplexer 10 (or CPU 19) in accordance with control signals, such as timing signals and the like, received from CPU 19. In preferred embodiments of the invention video decoder 11 is an MPEG decoder; however, any decoder may be used so long as the decoder is compatible with the type of coding used to code the video data. In this regard, video decoder 11 includes circuitry (not shown), comprised of a memory for storing a decoding module (not shown) and a microprocessor for executing the process steps in this module so as to decode coded video data. A detailed description of a video decoder that may be used in connection with the present invention is provided in U.S. patent application Ser. No. 09/094,828, entitled “Pixel Data Storage System For Use In Half-Pel Interpolation”, the contents of which are hereby incorporated by reference in to the subject application as if set forth herein in full. Of course, it should be noted that video decoding alternatively can be performed by CPU 19, thereby eliminating the need for video decoder 11. The details of the decoding process are provided below. For now, suffice it to say that video decoder 11 outputs decoded video data and transmits that decoded video data either to CPU 19 or to display processor 12.

Display processor 12 can comprise a microprocessor, microcontroller, or the like, which is capable of forming images from video data and of outputting those images to display screen 14. In operation, display processor 12 outputs a video sequence in accordance with control signals received from CPU 19 based on decoded video data received from video decoder 11 and based on graphics data received from CPU 19. More specifically, display processor 12 forms images from the decoded video data received from video decoder 11 and from the graphics data received from CPU 19, and inserts the images formed from the graphics data at appropriate points in the images (i.e., the video sequence) formed from the decoded video data. Specifically, display processor 12 uses image attributes, chroma-keying methods and region-object substituting methods in order to include (e.g., to superimpose) the graphics data in the data stream for the video sequence. This graphics data may correspond to any number of different types of images, such as station logos or the like. Additionally, the graphics data may comprise alternative advertising or the like, such as that described in U.S. patent application Ser. No. 09/062,939, entitled “Digital Television Which Selects Images For Display In A Video Sequence”, the contents of which are hereby incorporated by reference into the subject application as if set forth herein in full.

Audio decoder 15 is used to decode audio data packets associated with video data displayed on display screen 14. In preferred embodiments of the invention, audio decoder 15 comprises an AC3 audio decoder; however, other types of audio decoders may be used in conjunction with the present invention depending, of course, on the type of coding used to code the audio data. As shown in FIG. 3, audio decoder 15 operates in accordance with audio control signals received from CPU 19. These audio control signals include timing information and the like, and may include information for selectively outputting the audio data. Output from audio decoder 15 is provided to amplifier 16. Amplifier 16 comprises a conventional audio amplifier which adjusts an output audio signal in accordance with audio control signals relating to volume or the like input via input devices 25. Audio signals adjusted in this manner are then output via speakers 17.

CPU 19 comprises one or more microprocessors which are capable of executing stored program instructions (i.e., process steps) to control operations of digital television 2. These program instructions comprise software modules, or portions thereof, which are stored in either an internal memory of CPU 19, non-volatile storage 22, or ROM 24 (e.g., an EPROM), and which are executed out of RAM 21. These software modules may be updated via modem 20 and/or via the MPEG bitstream. That is, CPU 19 receives data from modem 20 and/or in the MPEG bitstream which may include, but is not limited to, software module updates, video data (e.g., graphics data or the like), audio data, etc.

FIG. 3 lists examples of software modules which are executable by CPU 19. As shown, these modules include control module 27, user interface module 29, application modules 30, and operating system module 31. Operating system module 31 controls execution of the various software modules running in CPU 19 and supports communication between these software modules. Operating system module 31 may also control data transfers between CPU 19 and various other components of digital television 2, such as ROM 24. User interface module 29 receives and processes data received from input devices 25, and causes CPU 19 to output control signals in accordance therewith. To this end, CPU 19 includes control module 27, which outputs such control signals together with other control signals, such as those described above, for controlling operation of various components in digital television 2.

Application modules 30 comprise software modules for implementing various signal processing features available on digital television 2. Application modules 30 can include both manufacturer-installed, i.e., “built-in”, applications and applications which are downloaded via modem 20 and/or the MPEG bitstream. Examples of well-known applications that may be included in digital television 2 are an electronic channel guide (“ECG”) module and a closed-captioning (“CC”) module. Applications modules 30 also includes resolution upscaling module 35, which implements the resolution upscaling process of the present invention, including bilinear interpolation when necessary. At this point, it is noted that the resolution upscaling process of the present invention can be implemented during video decoding or subsequent thereto. For the sake of clarity, however, the resolution upscaling process is described separately from video decoding.

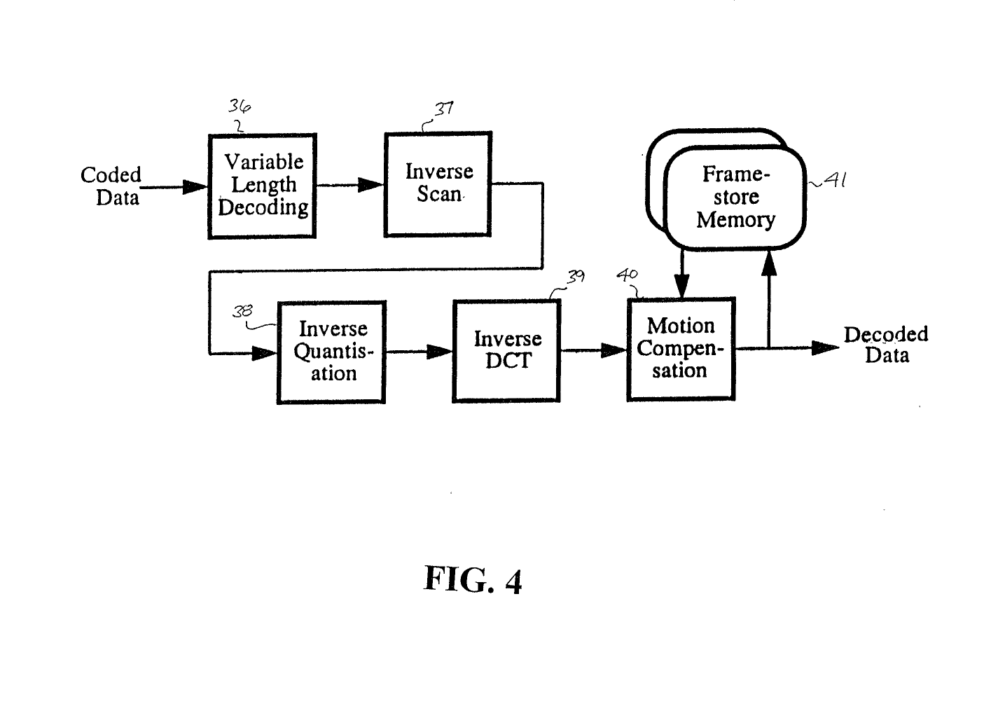

In this regard, FIG. 4 is a block diagram showing a preferred process for decoding MPEG-coded video data. As noted above, this process is preferably performed in video decoder 11, but may alternatively be performed by CPU 19. Thus, as shown in FIG. 4, coded data is input to variable-length decoder block 36, which performs variable-length decoding on the coded video data. Thereafter, inverse scan block 37 reorders the coded video data to correct for the pre-specified scanning order in which the coded video data was transmitted from the centralized location (e.g., the television studio). Inverse quantization is then performed on the coded video data in block 38, followed by inverse DCT processing in block 39. Motion compensation block 40 performs motion compensation on the video data output from inverse DCT block 39 so as to generate I, P and B frames of decoded video. Data for these frames is then stored in frame-store memories 41 on video decoder 11.

If resolution upscaling is not to be performed, this video data is output from frame-store-memories 41 to display processor 12, which then generates images therefrom and outputs those images to display 14. On the other hand, if resolution upscaling is to be performed on the decoded video data, the decoded video data is output to CPU 19, where it is processed by resolution upscaling module 35. At this point, it is noted that this processing may instead be performed in video decoder 11 or display processor 12, depending upon their capabilities and storage capacities.

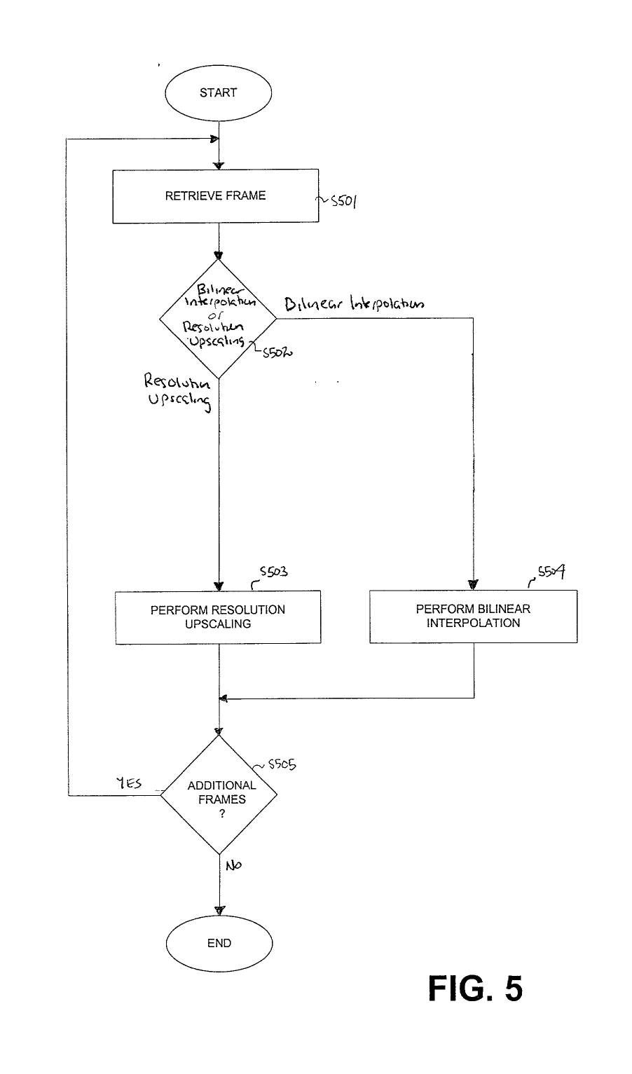

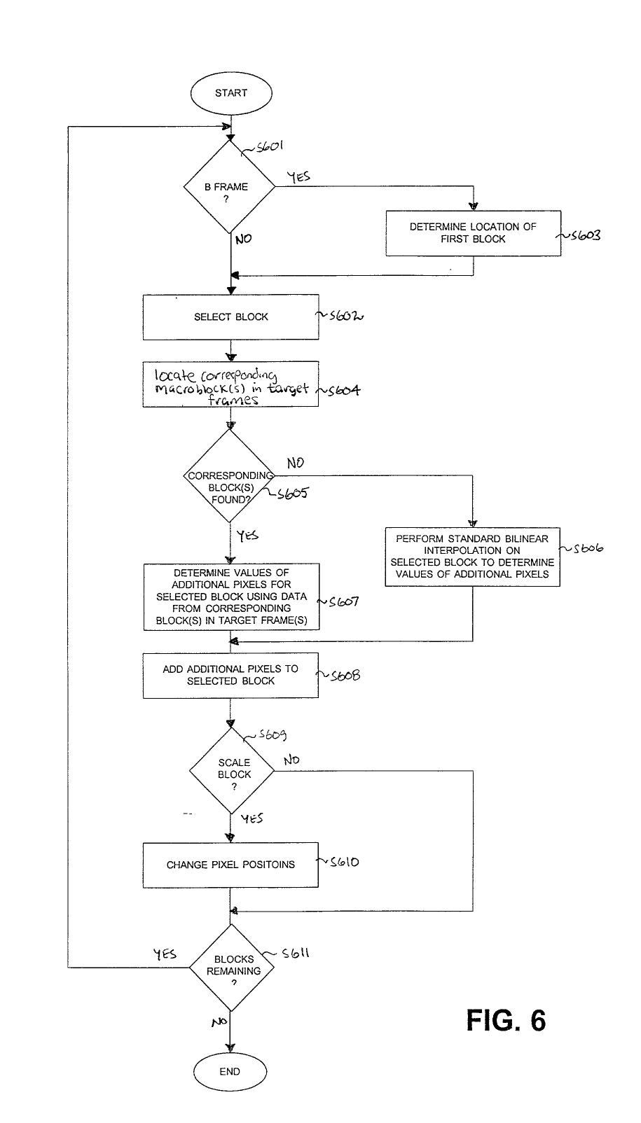

FIGS. 5 and 6 show process steps for implementing resolution upscaling module 35. When executed, e.g., by CPU 19, these process steps increase a resolution of at least a portion of a reference frame of video by (i) selecting a first block of pixels in the reference frame, (ii) locating, in N (N≧1) target frames, one or more blocks of pixels that substantially correspond to the first block of pixels, where the N target frames are separate from the reference frame, (iii) determining values of additional pixels based on values of pixels in the first block and on values of pixels in the one or more blocks, and (iv) adding the additional pixels among the pixels in the first block.

To begin the process, step S501 retrieves a reference frame of decoded video. In a preferred embodiment of the invention, this reference frame is retrieved from frame-store memories 41; although it may be retrieved from other sources as well. Step S502 then determines whether standard bilinear interpolation or resolution upscaling in accordance with the invention is to be performed on the retrieved frame. The determination as to whether to perform bilinear interpolation or resolution upscaling can be made based on one or more of a variety of factors including, but not limited to, the CPU's processing capability, time constraints, and available memory. In a case that resolution upscaling is to be performed, processing proceeds to step S503, described below. On the other hand, in a case that standard bilinear interpolation is to be performed, processing proceeds to step S504.

Step S504 performs standard bilinear interpretation on each macroblock of the reference frame in order to determine values of additional pixels for that macroblock, and to add those values intermittently among pixels already in the macroblock. As noted above, standard bilinear interpolation comprises determining values of additional pixels of a frame based on information in that frame and without regard to information in other frames.

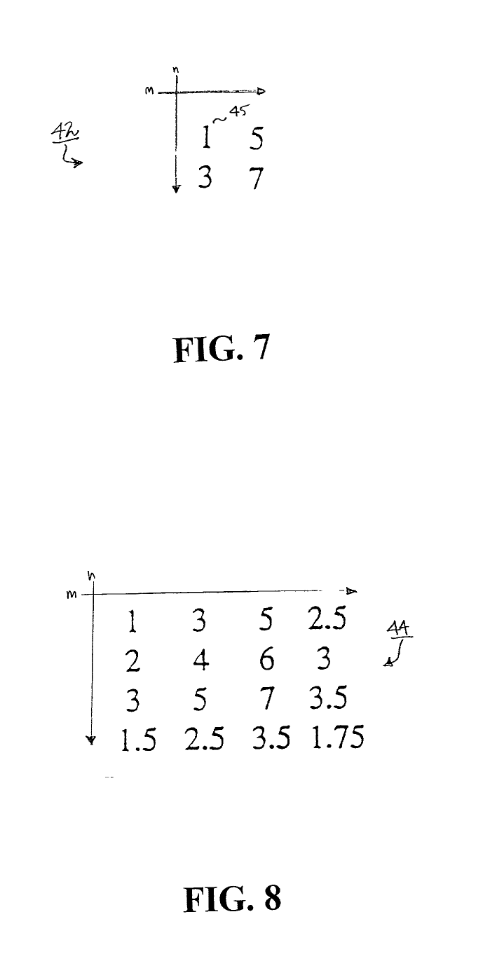

Thus, by way of example, step S504 interpolates each 2×2 pixel block of the reference frame, such as block 42 shown in FIG. 7, to generate a 4×4 pixel block, such as block 44 shown in FIG. 8. It is noted that step S504 preferably operates on macroblocks; however, a smaller 2×2 block is shown here for the sake of clarity. The resulting block may also be scaled. The block scaling process is described in more detail below.

In preferred embodiments of the invention, step S504 performs bilinear interpolation in accordance with equations (2) set forth below, wherein, for the purposes of the present example, u(m, n) comprise block 42, v(m, n) comprises block 44, pixel 45 of block 42 comprise the (0,0)^{th} pixel, and all pixel values outside of pixel block 42 have zero values.

v(2m, 2n)=u(m, n)

v(2m+1, 2n)=0.5[u(m, n)+u(m+1, n)]

v(2m,2n+1)=0.5[u(m, n)+u(m, n+1)]

v(2m+1, 2n+1)=0.25[u(m, n)+u(m+1, n)+u(m, n+1)+u(m+1,n+1)] (2)

Thus, taking the (0,0)^{th} pixel shown in FIG. 7 as an example (i.e., where both m and n equal 0), inputting the appropriate values into equations (2) yields values of 1, 2, 3 and 4 for v(0,0), v(0,1), v(1,0) and v(1,1), respectively, which correspond to the values shown in FIG. 8. Similar calculations can also be performed for the remaining (0,1)^{th},(1,0)^{th}, and (1,1)^{th} pixels of FIG. 7 in order to yield the remaining values shown in FIG. 8.

Returning to step S503, this step encompasses the process shown in FIG. 6. To begin, step S601 determines whether the reference frame is a B frame. This is typically done by examining the headers of data packets contained in the reference frame. If the current frame is an I or a P frame, processing proceeds to step S602, which is described in detail below. On the other hand, if the reference frame is a B frame, processing proceeds to step S603. Step S603 determines a location of the first block (e.g., a macroblock) in the reference frame based on blocks of pixels in frames which precede and which follow the reference frame. This step is usually performed only in a case that the reference frame is a B frame because B frames are not used to predict (i.e., target) frames, and thus blocks in those frames will not be readily identifiable as corresponding to blocks in the B frames.

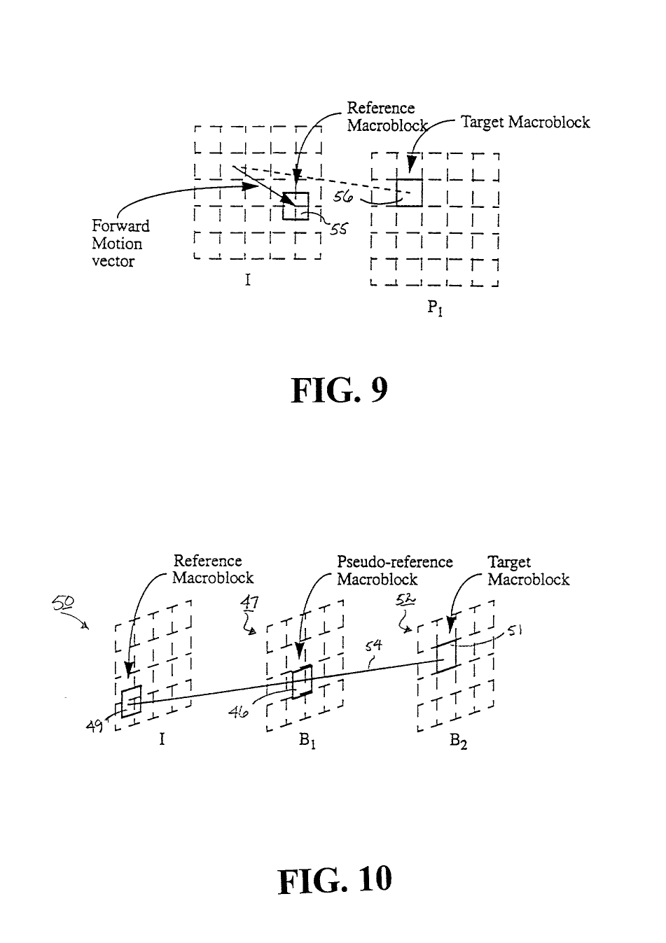

More specifically, as shown in FIG. 9, where the reference frame is an I or a P frame and the target frames are P or B frames, motion vectors relating to the reference frames can be used to determine which blocks in the target frames substantially correspond to blocks in the reference frames. The reason that this information is needed is described in more detail below. However, because B frames are not used to predict other frames, the B frames will have no motion vectors with which to identify corresponding blocks in the target frames. As a result, there is a need to determine a correspondence between blocks in the reference B frame and in succeeding or preceding target frames. This is done in step S603. Thus, as shown in FIG. 10, step S603 determines the location of pseudo-reference macroblock 46 in reference B frame 47 based on reference macroblock 49 in preceding I (or, alternatively, P) frame 50 and target macroblock 51 in B frame 52. In particular, pseudo-reference macroblock 46 is centered roughly at the point where motion vector 54 from I frame 50 to B frame 52 intersects B frame 47. FIG. 12 likewise shows determining a reference macroblock in a B frame, namely frame B₂ using a target P frame (P₂) and a reference B frame (B₁).

Following step S603, or alternatively step S601, processing proceeds to step S602. Step S602 selects a macroblock of pixels in the reference frame for resolution upscaling (e.g., block 55 of FIG. 9). In the case of I or P frames, this selection is determined based on whether there is a block in the target frame (e.g., block 56 of FIG. 9) that maps back to the reference frame. That is, in step S602, any block in the reference frame that has a corresponding block in the target frame can be selected. In a case that the reference frame is a B frame, however, the pseudo-reference macroblock determined in step S603 is selected in this step. Thereafter, step S604 locates macroblock(s) in one or more previously-retrieved target frames that substantially correspond to the selected macroblock. In the case of MPEG-coded data, these macroblock(s) are located using motion vectors. That is, in step S604, the motion vectors for the target frame can be used to locate the blocks in the target frames. Of course, the invention is not limited to using motion vectors to locate the macroblock(s). Rather, the target frame may be searched for the appropriate macroblock(s). In any case, it is noted that step S604 does not require exact correspondence between the macroblocks in the reference and target frames. Rather, only substantial correspondence is sufficient, meaning that the macroblocks in the reference frame have a certain amount or percentage of data which is similar to data in the macroblocks for the target frames. This amount or percentage may be set in CPU 19 or “hard-coded” in resolution upscaling module 35, if desired.

As noted above, the invention locates corresponding macroblocks in one or more target frames. By including the capability to locate macroblocks in more than one target frame, the invention enables “back projecting” of information from various target frames to use in determining additional pixels in a single reference frame. This is particularly advantageous in cases where the target frames were predicted, at least in part, based on pixels in the reference frame. That is, because macroblocks in various frames may be predicted from the same macroblock in the reference frame, information from those various frames can be used to calculate the additional pixels in the reference frame. Using information from these various macroblocks serves to increase the accuracy of the resolution-upscaled reference frame.

Following step S604, processing proceeds to step S605. Step S605 determines whether there are any macroblocks in the target frame(s) that substantially correspond to the macroblock selected in step S602. If no such macroblocks are found (or, alternatively, if no target frame exists), this means that the selected macroblock has not been used to predict a frame. In this case, processing proceeds to step S606, in which the values of additional pixels for the selected macroblock are determined based on at least some of the pixels in the selected macroblock without regard to pixels in the target frames. A preferred method for determining these pixel values is bilinear interpolation, which was described above with respect to FIG. 5 (see equations (2) above).

On the other hand, if at least one corresponding macroblock has been found in step S605, processing proceeds to step S607. Step S607 determines values of additional pixels in the selected macroblock based on values of pixels already in the macroblock and based on values of pixels in any corresponding macroblocks. The values of these additional pixels are also determined in accordance with coefficients, the values for which are determined in the manner described below.

More specifically, in the preferred embodiment of the invention, step S607 performs resolution upscaling in accordance with equations (3) set forth below, wherein u_{I}(m, n) comprises pixel values in the selected macroblock (e.g., block 55 of FIG. 9), u_{P1}(m, n) comprises pixel values in a corresponding macroblock from a target frame (e.g., block 56 of FIG. 9), and v_{I}(m, n) comprises pixel values for a resolution-upscaled macroblock which is determined based on pixel values in u_{I}(m, n) and u_{P1}(m, n). Specifically, values of pixels from respective macroblocks in the reference and target frames are inserted into the following equations in order to determine pixel values for v_{I}(m, n):

$$\begin{matrix}{v}_{I} ( 2 m , 2 n ) = {c}_{1} {u}_{I} ( m , n ) + {c}_{2} {u}_{P1} ( m , n ) \\ {v}_{I} ( 2 m + 1 , 2 n ) = {c}_{1} [ 0.5 ( {u}_{I} ( m , n ) + {u}_{I} ( m + 1 , n ) ) ] + \\ {c}_{2} [ 0.5 ( {u}_{P1} ( m , n ) + {u}_{P1} ( m + 1 , n ) ) ] \\ {v}_{I} ( 2 m , 2 n + 1 ) = {c}_{1} [ 0.5 ( {u}_{I} ( m , n ) + {u}_{I} ( m , n + 1 ) ) ] + \\ {c}_{2} [ 0.5 ( {u}_{P1} ( m , n ) + {u}_{P1} ( m , n + 1 ) ) ] , \\ {v}_{I} ( 2 m + 1 , 2 n + 1 ) = {c}_{1} [ 0.25 ( {u}_{I} ( m , n ) + {u}_{I} ( m + 1 , n ) + \\ {u}_{I} ( m , n + 1 ) + {u}_{I} ( m + 1 , n + 1 ) ) ] + \\ {c}_{2} [ 0.25 ( {u}_{P1} ( m , n ) + {u}_{P1} ( m + 1 , n ) + \\ {u}_{P1} ( m , n + 1 ) + {u}_{P1} ( m + 1 , n + 1 ) ) ]\end{matrix} \qquad ( 3 )$$

where, for the 16×16 pixel macroblocks under consideration, 0≦m, and n≦15. Of course, these values will change in cases where differently-sized blocks are being processed.

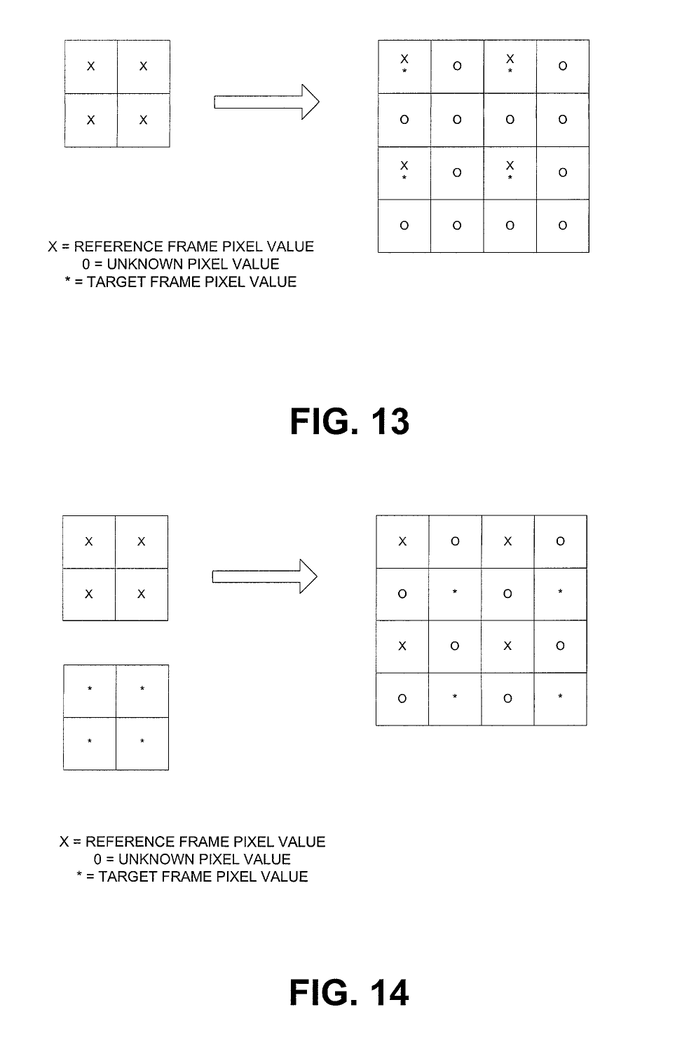

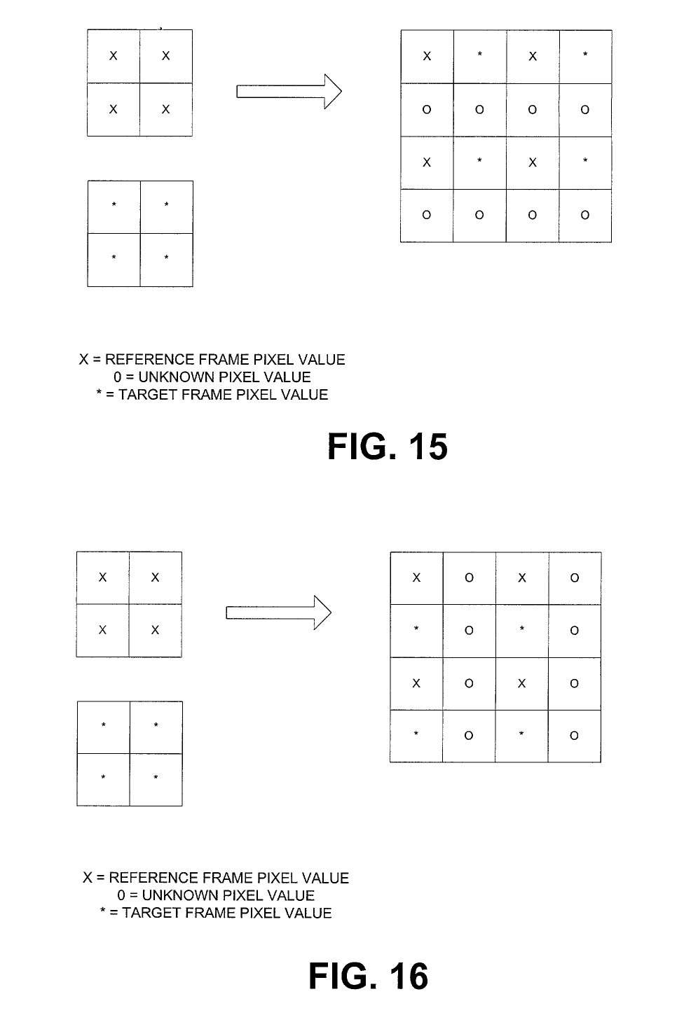

In the case of MPEG, motion vectors may have half-pel (i.e., half pixel) accuracy. See U.S. patent application Ser. No. 09/094,828 incorporated by reference above. In cases where the motion vectors have half-pel accuracy, the accuracy of the present invention is even further increased, since pixel values from the target frames with half-pel motion vectors provide information about the additional pixels in the reference block whose values are to be determined. For example, FIG. 13 shows upscaling reference block 70 to produce upscaled block 71 using a target block which does not include half-pel motion vectors. On the other hand, FIGS. 14 to 16 show upscaling reference block 70 to produce upscaled blocks 73, 74 and 75, respectively, using a target block 72 which includes half-pel motion vectors. By contrasting FIG. 13 with FIGS. 14 to 16, it is apparent that there are fewer unknown pixels values in the blocks which are to be upscaled using half-pel motion vectors than in the block that was upscaled without their use. In the ensuing interpolation, this leads to more accurately upscaled blocks in the cases shown in FIGS. 14 to 16.

In equations (3) above, the values of coefficients c₁ and c₂ vary between 0 and 1, and total 1 when added together. Variations in the weights of these coefficients depend upon the weight that is to be given to pixels in each block. For example, if a greater weight is to be given to pixels in the reference frame, the value of c₁ will be higher than that of c₂, and vice versa. In this regard, the values of coefficients c₁ and c₂ is determined based on differences between pixels in the macroblock selected from the reference frame and those in the corresponding macroblock found in the target frame. In MPEG, this difference comprises the residual. If the residual has high DCT coefficient values, then the coefficient values for the corresponding block from the target frame should be relatively low, and vice versa.

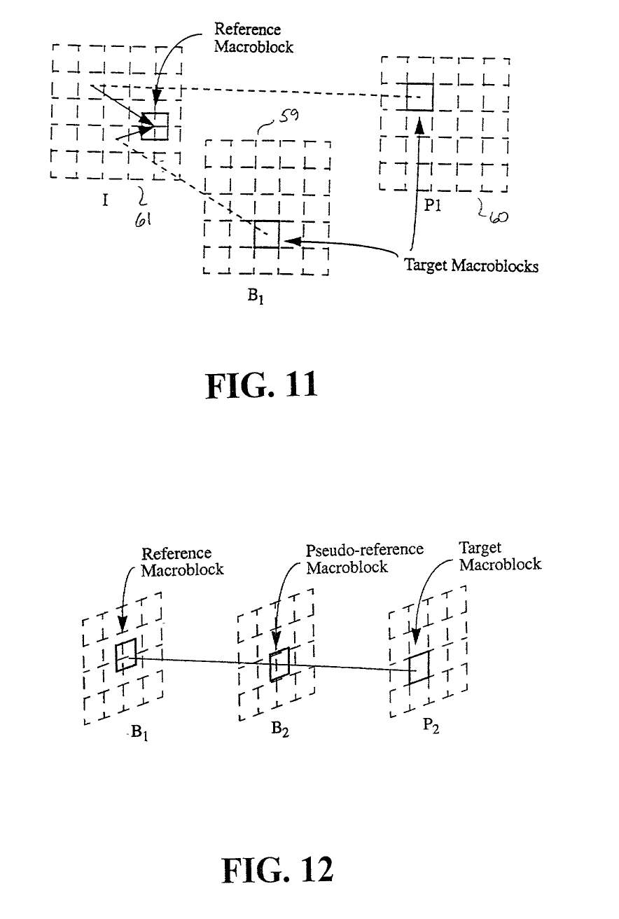

The foregoing example pertains to determining additional pixel values for a macroblock in a reference frame using a macroblock from a single target P frame. However, as noted above, macroblocks from various target P and B frames may be used to determine these additional pixel values. For example, as shown in FIG. 11, macroblocks from both frames 59 (B₁) and 60 (P₁) may be used to determine additional pixel values for reference frame 61 (I). In this regard, where N (N>1) target frames are used to determine additional pixel values for a reference frame I, equations (3) above generalize to equations (4), as follows

$$\begin{matrix}{v}_{I} ( 2 m , 2 n ) = {c}_{1} {u}_{I} ( m , n ) + {c}_{2} {u}_{1} ( m , n ) … + {c}_{N + 1} {u}_{N} ( m , n ) \\ {v}_{I} ( 2 m + 1 , 2 n ) = {c}_{1} [ 0.5 ( {u}_{I} ( m , n ) + {u}_{I} ( m + 1 , n ) ) ] + \\ {c}_{2} [ 0.5 ( {u}_{1} ( m , n ) + {u}_{1} ( m + 1 , n ) ) ] + \\ … {c}_{N + 1} [ 0.5 ( {u}_{N} ( m , n ) + {u}_{N} ( m + 1 , n ) ) ] \\ {v}_{I} ( 2 m , 2 n + 1 ) = {c}_{1} [ 0.5 ( {u}_{I} ( m , n ) + {u}_{I} ( m , n + 1 ) ) ] + \\ {c}_{2} [ 0.5 ( {u}_{1} ( m , n ) + {u}_{1} ( m , n + 1 ) ) ] + \\ … {C}_{N + 1} [ 0.5 ( {u}_{N} ( m , n ) + {u}_{N} ( m , n + 1 ) ) ] . \\ {v}_{I} ( 2 m + 1 , 2 n + 1 ) = {c}_{1} [ 0.25 ( {u}_{I} ( m , n ) + {u}_{I} ( m + 1 , n ) + \\ {u}_{I} ( m , n + 1 ) + {u}_{I} ( m + 1 , n + 1 ) ) ] + \\ {c}_{2} [ 0.25 ( {u}_{1} ( m , n ) + {u}_{1} ( m + 1 , n ) + \\ {u}_{1} ( m , n + 1 ) + {u}_{1} ( m + 1 , n + 1 ) ) ] + \\ … {c}_{N + 1} [ 0.25 ( {u}_{N} ( m , n ) + {u}_{N} ( m + 1 , n ) + \\ {u}_{N} ( m , n + 1 ) + {u}_{N} ( m + 1 , n + 1 ) ) ]\end{matrix} \qquad ( 4 )$$

As was the case above, coefficients c₁, c₂ . . . c_{N+1} vary between 0 and 1, and total 1 when added together.

It is further noted that equations (4) above also pertain to the specific case of doubling the resolution of video, hence the use of “0.5” in the equations for v_{I}(2 m+1, 2 n) and v_{I}(2 m, 2 n+1), and the use of “0.25” in the equation for v_{I}(2 m+1, 2 n+1). To obtain a different multiple resolution (e.g., triple resolution), different constants may be used, so long as those constants sum to 1. Of course, in this case, additional equations will also be required, since there will be a need to determine more pixel locations. Once armed with the disclosure provided herein, one of ordinary skill in the art would be able to generate such equations readily. Accordingly, detailed descriptions thereof are omitted herein for the sake of brevity.

Next, step S608 adds the pixels determined either in step S606 or step S607 above to the selected macroblock, thereby increasing its resolution. Thereafter, step S609 determines whether to scale the selected macroblock. Scaling comprises increasing or decreasing distances between pixels in the macroblock in order to change the macroblock's size. It may be performed in response to user-input commands, such as a “zoom” command or, alternatively, it may be performed automatically by the invention in order to fit the video to a particular display size or type (e.g., a high-resolution screen). In accordance with the present invention, scaling can be incorporated into steps S606 and S607 above; however, for the sake of clarity, it is presented separately here.

If scaling is to be performed, processing proceeds to step S610. Step S610 moves the pixels in the selected macroblock (e.g., by increasing and/or decreasing the distances therebetween) in order to achieve a desired block size. Using the invention, it is thus possible to generate, e.g., a macroblock having twice the size and substantially the same resolution as the original macroblock, a macroblock having substantially the same size as the original macroblock but a multiple of its resolution, etc. Also, using the invention, it is possible to distort frames by scaling only selected macroblocks. In any case, following step S610, or alternatively step S609 (when scaling is not performed), processing proceeds to step S611.

Step S611 determines whether there are any additional macroblocks in the current frame that need to be processed. In the event that there are such macroblocks, processing returns to step S601, whereafter the foregoing is repeated. On the other hand, if there are no remaining macroblocks in the current frame, the processing in FIG. 6 ends.

Returning to FIG. 5, the next step in the process is step S505. Step S505 determines whether there are additional frames of decoded video to be processed. In the event that there are additional frames of video in the current video sequence, processing returns to step S501, where the foregoing is repeated for those additional frames. On the other hand, if there are no additional frames, processing ends.

As noted above, although the invention has been described in the context of a stand-alone digital television, it can be used with any digital video device. Thus, for example, if the invention is used in a settop box, the processing shown in FIGS. 5 and 6 generally will be performed in that box's processor and/or equivalent hardware designed to perform the necessary calculations. The same is true for a personal computer, video-conferencing equipment, or the like. Finally it noted that the process steps shown in FIGS. 5 and 6 need not necessarily be executed in the exact order shown, and that the order shown is merely one way for the invention to operate. Thus, other orders of execution are permissible, so long as the functionality of the invention is substantially maintained.

The present invention has been described with respect to a particular illustrative embodiment. It is to be understood that the invention is not limited to the above-described embodiment and modifications thereto, and that various changes and modifications may be made by those of ordinary skill in the art without departing from the spirit and scope of the appended claims.

What is claimed is:

1. A method of increasing a resolution of at least a portion of a reference frame of video, the method comprising the steps of:
selecting a first block of pixels in the reference frame;
locating, in N (N≧1) target frames, one or more blocks of pixels that substantially correspond to the first block of pixels, where the N target frames are separate from the reference frame;
determining values of additional pixels based on values of pixels in the first block and on values of pixels in the one or more blocks; and
adding the additional pixels among the pixels in the first block.

2. A method according to claim 1, wherein the N target frames comprise frames of video which were predicted, at least in part, based on pixels in the reference frame.

3. A method according to claim 1, wherein the determining step determines the values of the additional pixels based also on coefficients which are weighted in accordance with the first block and the one or more blocks.

4. A method according to claim 3, wherein the coefficients are weighted based on differences between pixels in the first block and pixels in each of the one or more blocks.

5. A method according to claim 4, wherein the differences comprise an MPEG residual.

6. A method according to claim 1, wherein, in a case that the locating step does not locate any blocks of pixels in the target frames that substantially correspond to the first block of pixels, the determining step determines the values of the additional pixels based on values of pixels in the first block without regard to values of pixels in the N target frames.

7. A method according to claim 6, wherein the determining step determines the values of the additional pixels by performing bilinear interpolation using at least some of the pixels in the first block.

8. A method according to claim 1, wherein the reference frame of video and the N target frames are coded using one of MPEG-1, MPEG-2 and MPEG-4.

9. A method according to claim 8, wherein the reference frame comprises a bi-directional (B) frame; and
wherein the method further comprises, before the selecting step, the step of determining a location of the first block in the reference frame based on blocks of pixels in frames which precede and which follow the reference frame.

10. A method according to claim 8, wherein the reference frame comprises one of an intramode (I) frame and a predictive (P) frame; and
wherein the N target frames comprise at least one of a P frame and a bi-directional (B) frame.

11. A method according to claim 1, further comprising the step of changing distances between pixels in the first block in order to change a size of the first block.

12. A method according to claim 1, wherein the locating step uses motion vectors from the reference frame to the target frame to locate the one or more blocks of pixels.

13. A method according to claim 1, wherein the locating step searches through the N target frames to locate the one or more blocks of pixels.

14. Computer-executable process steps stored on a computer-readable medium, the computer-executable process steps to increase a resolution of at least a portion of a reference frame of video, the computer-executable process steps comprising:
code to select a first block of pixels in the reference frame;
code to locate, in N (N≧1) target frames, one or more blocks of pixels that substantially correspond to the first block of pixels, where the N target frames are separate from the reference frame;
code to determine values of additional pixels based on values of pixels in the first block and on values of pixels in the one or more blocks; and
code to add the additional pixels among the pixels in the first block.

15. Computer-executable process steps according to claim 14, wherein the N target frames comprise frames of video which were predicted, at least in part, based on pixels in the reference frame.

16. Computer-executable process steps according to claim 14, wherein the determining code determines the values of the additional pixels based also on coefficients which are weighted in accordance with the first block and the one or more blocks.

17. Computer-executable process steps according to claim 16, wherein the coefficients are weighted based on differences between pixels in the first block and pixels in each of the one or more blocks.

18. A method according to claim 17, wherein the differences comprise an MPEG residual.

19. Computer-executable process steps according to claim 14, wherein, in a case that the locating code does not locate any blocks of pixels in the target frames that substantially correspond to the first block of pixels, the determining code determines the values of the additional pixels based on values of pixels in the first block without regard to values of pixels in the N target frames.

20. Computer-executable process steps according to claim 19, wherein the determining code determines the values of the additional pixels by performing bilinear interpolation using at least some of the pixels in the first block.

21. Computer-executable process steps according to claim 14, wherein the reference frame of video and the N target frames are coded using one of MPEG-1, MPEG-2 and MPEG-4.

22. Computer-executable process steps according to claim 21, wherein the reference frame comprises a bi-directional (B) frame; and
wherein the computer-executable process steps further comprise code to determine a location of the first block in the reference frame based on blocks of pixels in frames which precede and which follow the reference frame.

23. Computer-executable process steps according to claim 21, wherein the reference frame comprises one of an intramode (I) frame and a predictive (P) frame; and
wherein the N target frames comprise at least one of a P frame and a bi-directional (B) frame.

24. Computer-executable process steps according to claim 14, further comprising code to change distances between pixels in the first block in order to change a size of the first block.

25. Computer-executable process steps according to claim 14, wherein the locating code uses motion vectors from the reference frame to the target frame to locate the one or more blocks of pixels.

26. Computer-executable process steps according to claim 14, wherein the locating code searches through the N target frames to locate the one or more blocks of pixels.

27. An apparatus for increasing a resolution of at least a portion of a reference frame of video, the apparatus comprising:
a memory which stores computer-executable process steps; and
a processor which executes the process steps so as (i) to select a first block of pixels in the reference frame, (ii) to locate, in N (N≧1) target frames, one or more blocks of pixels that substantially correspond to the first block of pixels, where the N target frames are separate from the reference frame, (iii) to determine values of additional pixels based on values of pixels in the first block and on values of pixels in the one or more blocks, and (iv) to add the additional pixels among the pixels in the first block.

28. An apparatus according to claim 27, wherein the N target frames comprise frames of video which were predicted, at least in part, based on pixels in the reference frame.

29. An apparatus according to claim 27, wherein the processor determines the values of the additional pixels based also on coefficients which are weighted in accordance with the first block and the one or more blocks.

30. An apparatus according to claim 29, wherein the coefficients are weighted based on differences between pixels in the first block and pixels in each of the one or more blocks.

31. A method according to claim 30, wherein the differences comprise an MPEG residual.

32. An apparatus according to claim 27, wherein, in a case that the processor does not locate any blocks of pixels in the target frames that substantially correspond to the first block of pixels, the processor determines the values of the additional pixels based on values of pixels in the first block without regard to values of pixels in the N target frames.

33. An apparatus according to claim 32, wherein the processor determines the values of the additional pixels by performing bilinear interpolation using at least some of the pixels in the first block.

34. An apparatus according to claim 27, wherein the reference frame of video and the N target frames are coded using one of MPEG-1, MPEG-2 and MPEG-4.

35. An apparatus according to claim 34, wherein the reference frame comprises a bi-directional (B) frame; and
wherein, before selecting the first block, the processor executes process steps so as to determine a location of the first block in the reference frame based on blocks of pixels in frames which precede and which follow the reference frame.

36. An apparatus according to claim 34, wherein the reference frame comprises one of an intramode (I) frame and a predictive (P) frame; and
wherein the N target frames comprise at least one of a P frame and a bi-directional (B) frame.

37. An apparatus according to claim 27, wherein the processor executes process steps so as to change distances between pixels in the first block in order to change a size of the first block.

38. A method according to claim 27, wherein the processor uses motion vectors from the reference frame to the target frame to locate the one or more blocks of pixels.

39. A method according to claim 27, wherein the processor searches through the N target frames to locate the one or more blocks of pixels.

40. An apparatus for increasing a resolution of at least a portion of a reference frame of video, the apparatus comprising:
means for selecting a first block of pixels in the reference frame;
means for locating, in N (N≧1) target frames, one or more blocks of pixels that substantially correspond to the first block of pixels, where the N target frames are separate from the reference frame;
means for determining values of additional pixels based on values of pixels in the first block and on values of pixels in the one or more blocks; and
means for adding the additional pixels among the pixels in the first block.

41. A television system which receives coded video data, and which forms images based on the coded video data, the television system comprising:
a decoder which decodes the video data to produce frames of video;
a processor which increases a resolution of a reference frame of the video based on pixels in the reference frame and based on pixels in at least one other target frame of the video; and
a display which displays an image based on the reference frame.

42. A television system according to claim 41, wherein the processor increases the resolution of the reference frame by selecting blocks of pixels in the reference frame and, for each selected block, (i) locating, in N (N≧1) target frames, one or more blocks of pixels that substantially correspond to the first block of pixels, where the N target frames are separate from the reference frame; (ii) determining values of additional pixels based on values of pixels in the selected block and on values of pixels in the one or more blocks, and (iii) adding the additional pixels among the pixels in the selected block.

43. A television system according to claim 41, wherein, in a case that the processor does not locate any blocks of pixels in the target frames that substantially correspond to the selected block of pixels, the processor determines the values of the additional pixels based on values of pixels in the selected block without regard to values of pixels in the N target frames.

44. A television system according to claim 41, wherein the decoder and the processor are implemented in a settop box.

45. A method according to claim 4, wherein, in a case that the reference and target frames of video are coded using MPEG, the locating step locates the one or more blocks using motion vectors present in an MPEG bitstream for the target frames; and
wherein the coefficients are determined using DCT values of at least one coded residual, where the at least one coded residual comprises differences between the reference frame and the target frame(s).

46. Computer-executable process steps according to claim 17, wherein, in a case that the reference and target frames of video are coded using MPEG, the locating code locates the one or more blocks using motion vectors present in an MPEG bitstream for the target frames; and
wherein the coefficients are determined using DCT values of at least one coded residual, where the at least one coded residual comprises differences between the reference frame and the target frame(s).

47. An apparatus according to claim 30, wherein, in a case that the reference and target frames of video are coded using MPEG, the locating step locates the one or more blocks using motion vectors present in an MPEG bitstream for the target frames; and
wherein the coefficients are determined using DCT values of at least one coded residual, where the at least one coded residual comprises differences between the reference frame and the target frame(s).
